(19) United States
(12) Patent Application Publication
(10) Pub. No.: US 2004/0030926 A1
(43) Pub. Date: Feb. 12, 2004

(54) Multi-session secured digital transmission process

(76) Inventor: James R. Clark, Aurora, CO (US)

Correspondence Address: Ken J Pedersen, Pedersen & Company, PO Box 2666, Boise, ID, 83701-2666, US

(21) Appl. No.: 10/312,104

(22) PCT Filed: Jun. 20, 2001
(86) PCT No.: PCT/US01/19831

(30) Foreign Application Priority Data
Jun. 20, 2000 (US) 60213607

(51) Int. Cl. G06F 15/16

(52) U.S. Cl. 713/201; 709/227

(57) ABSTRACT

The present invention provides secured Internet data transactions by typically encrypting the data, opening up multiple IP sessions, breaking up the data, and sending the discrete, typically encrypted packets of information along separate paths to secured servers that send it to a destination server that then recompiles the data into a usable format. The source of the data is any Internet device that is first authenticated via a phone connection, Web site, or other connection, through a serial number or other unique identifier, then confirmed, and then sent to multi-session secured servers. The Internet device is authenticated and secured through a unique hardware identifier. The thus secured Internet device may then access the multi-session secured servers. These servers will only except and transmit information with these authenticated and secured devices.

### DESCRIPTION

### BACKGROUND OF THE INVENTION

1. Field of the Invention

Embodiments of the present invention relate to digitally encoded data of any kind that is intended for transmission via the Internet. More specifically, the present invention relates to a totally secure multi-session secured digital transmission process which allows for the secure transmission of data over the Internet.

### SUMMARY OF THE INVENTION

As an introduction to the problems solved by the present invention, consider that the expansion of usage of the Internet has created a demand for high levels of security over what is basically an open digital communications network. To provide security and privacy in the digital transmission of data, a large variety of creative encryption and security procedures currently exist.

The present invention described herein can protect any type of digitally encoded data that is able to be transmitted via the Internet, of both encrypted and non-encrypted forms. The system uses a novel and innovative process, not to replace existing techniques, but to enhance them by adding two additional layers of security. The Multi-Session Secured Digital Transmission (“MSSDT”) process of the present invention will provide secured transactions over the Internet, such as credit card purchases and direct electronic debits from bank accounts. MSSDT provides the secure transaction capability utilizing the unique proprietary features of the Copy-protected Internet Distribution System (described in co-pending U.S. Provisional Patent Application No. 60/212,638 entitled “Copy-Protected Internet Distribution System”, filed Jun. 19, 2000, which is incorporated herein by reference), which allows authentication from a pre-identified and authorized Internet device to transfer information in a secured format using proprietary security technology, including encryption, cross-identification, and ID profiles.

In the preferred embodiment of the invention, the customer end of a secured Internet data link utilizes a specialized server, called an authentication center server. The authentication center server authenticates and registers a unique hardware identifier within the Internet device such that said device may access the MSSDT system as a Secured Internet Device (SID). A SID is an Internet device which has had an embedded unique identifier authenticated and registered with the MSSDT system. Data is then transmitted from the SID using contemporary encryption techniques, but the data stream is separated in an interleaved-word fashion onto multiple IP sessions, on separate IP ports to Multi-Session (MS) security servers. Each MS security server then communicates the data to a single MS destination server over a private network. The linkages are further secured via the authentication process described above, that is separate from any other communications link. As put forth in the detailed description that follows, this novel Multi-Session Secured Digital Transmission Process will provide great benefit to its users by providing a means to totally secure their critical data.

### BRIEF DESCRIPTTON OF THE DRAWINGS

FIG. 1 is a schematic drawing of a Multi-Session Secured Digital Transmission Process according to one embodiment of the present invention.

FIG. 2 is a schematic representation of a typical data slicing technique, as used in this invention.

### DETAILED DESCRIPTION OF THE INVENTION

The present invention provides totally secure Internet transactions by providing multiple IP sessions for each transaction. Data is transmitted from any authenticated Internet device through multiple IP ports. The data is typically first encrypted, and then divided into multiple packets of information. The data is then addressed to multiple secured servers in discrete, separate, typically encrypted, packages. The data is then sent from the multiple secured servers to a secured distribution server. The secured distribution server is able to recognize and identify the IP address of each packet of information from the multiple secured servers. The received data is then programmatically re-assembled and de-encrypted.

In order to access the novel system, the Internet device must first be authenticated. This is done by accessing an authentication center which authenticates the Internet device and communicates with the multiple secured servers thereby enabling the now authenticated Internet device to access the multiple secured servers. The authentication process is accomplished through the utilization of a unique serial number for each Internet device. This could be a MAC code on a network card, a serial number in an EPROM, or a unique identification number on a CPU or other IC of any type. For example, the unique identification embedded in each Pentium III® chip could serve as a device specific identifier used to authenticate and register the specific device requesting access. This number is registered with the system web site through which access to the MSSDT system is granted.

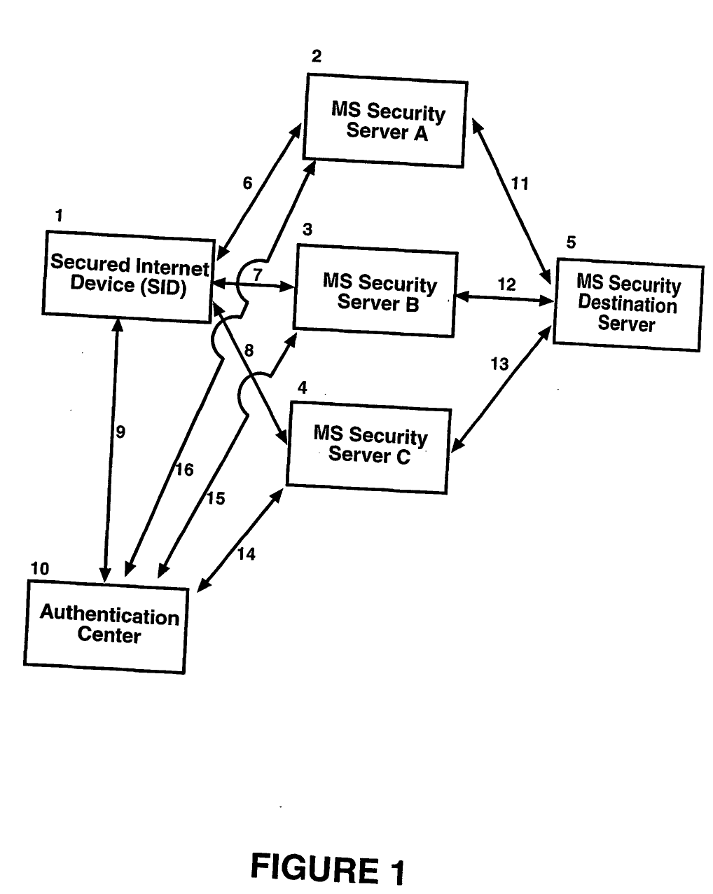

The present invention may be better understood by reference to the Figures. Referring to FIG. 1, a schematic drawing of a Multi-Session Secured Digital Transmission Process according to one embodiment of the present invention. The Secured Internet Device (SID) 1 is an Internet server that can communicate over multiple IP ports 6, 7, 8. The SID software separates consecutive data words to be sent out by these separate SID IP ports 6, 7, 8, interleaving the data in consecutive slices. The data is addressed to separate MS security servers: server A 2, server B 3, and server C 4. There may be any number of MS security servers (not shown) used in this manner. The MS security servers, server A 2, server B 3, and server C 4, then transmit the data to the MS security destination server 5 via private data links 11, 12, 13. An authentication center 10 is utilized when a connection is first established between the SID 1 and the array of MS security servers, server A 2, server B 3, and server C 4. This authentication center 10 ensures that the SID device 1 is authorized to have connection to the MS security servers, server A 2, server B 3, and server C 4.

Prior to the transmission of any data from the SID 1 to the MS security servers, server A 2, server B 3, and server C 4, the SID 1 first must be authenticated by the authentication center 10. The SID 1 communicates with the authentication center 10 over IP port 9. The authentication process is accomplished through the utilization of a unique serial number for each Internet device. This could be a MAC code on a network card, a serial number in an EPROM, or a unique identification number on a CPU or other IC of any type. For example, the unique identification embedded in each Pentium III® chip could serve as a device specific identifier used to authenticate and register the specific device requesting access. This number is registered with the system web site through which access to the MS SDT system is granted. Once the SID 1 is authenticated, the authentication center 10 communicates with the MS security servers, server A 2, server B 3, and server C 4, enabling the SID 1 to access the MS security servers. The authentication center 10 communicates with the MS security servers, server A 2, server B 3, and server C 4, over IP ports 14, 15, and 16.

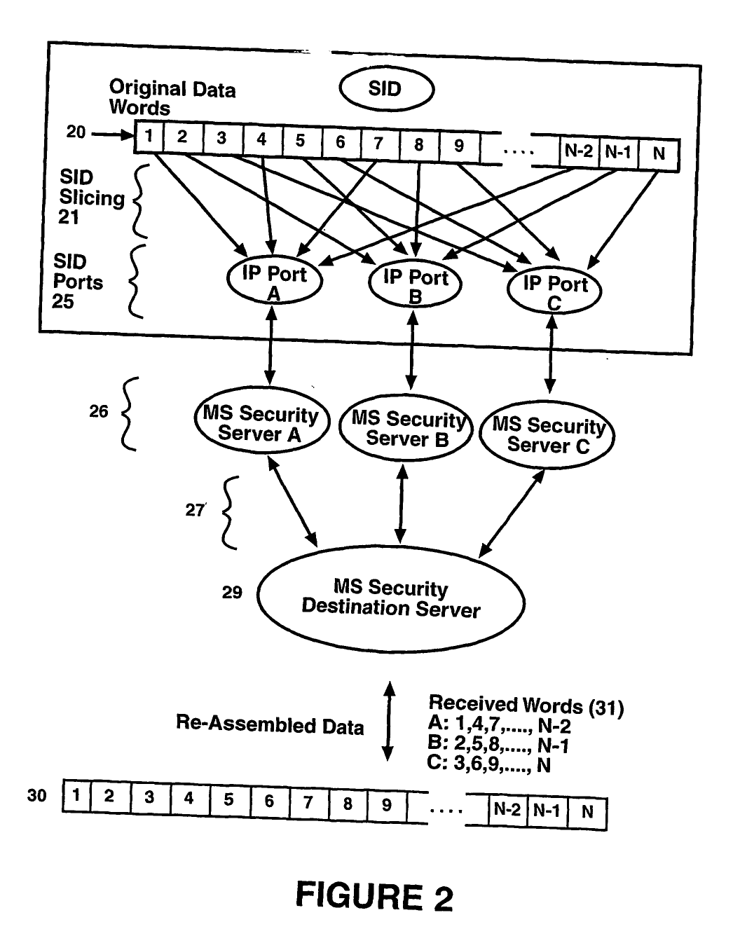

FIG. 2 is a schematic representation of a typical data slicing technique, as used in this invention. The way that data is sliced and sent is illustrated, beginning with an original data word 20. The SID slicing technique 21 is shown in this example using three MS security servers 26, whereby the data is sliced three ways. The sliced data is transmitted via the three IP ports 25 to the three MS security servers 26. These servers, in turn, transmit the data across private network 27 to the MS security destination server 29, where the received data words 31 are then programmatically re-assembled 30.

The advantages of this invention for the secure communication of secured data will be beneficial toward retail transactions, financial institution transactions and the like.

Although this invention has been described above with reference to particular means, materials and embodiments, it is to be understood that the invention is not limited to these disclosed particulars, but extends to all equivalents within the field of this invention.

Although this invention has been described above with reference to particular means, materials and embodiments, it is to be understood that the invention is not limited to these disclosed particulars, but extends instead to all equivalents within the scope of the following claims.

I claim:

1. A secured digital transmission process, comprising:
authenticating and registering a unique hardware identifier within an Internet device;
permitting said authenticated and registered Internet device to access a plurality security servers;
transmitting data from said authenticated and registered Internet device over the Internet onto multiple IP sessions, and on separate IP ports, to a plurality of security servers; and,
further transmitting data from said plurality of security servers to a destination server over a private network.

2. The process of claim 1 wherein said plurality of security servers are also authenticated and registered.

3. The process of claim 1 wherein the data from said authenticated and registered Internet device to said plurality of security servers is separated in an interleaved-word fashion.

4. A secured digital transmission system, comprising:
an Internet device with a unique hardware identifier;
an authentication center server in Internet connection with said Internet device and a plurality of security servers, said authentication center server permitting said Internet device, when authenticated and registered, to access a plurality of security servers;
said plurality of security servers being in Internet connection with said authenticated and registered Internet device and in private network connection with a destination server for transmitting data from said authenticated and registered Internet device to said destination server onto multiple IP sessions and on separate IP ports.
